(19) United States
(12) Patent Application Publication
(10) Pub. No.: US 2023/0222335 A1
(43) Pub. Date: Jul. 13, 2023

(54) TRAINING USER AUTHENTICATION MODELS WITH FEDERATED LEARNING

(71) Applicant: QUALCOMM Incorporated, San Diego, CA (US)

(72) Inventors: Hossein HOSSEINI, San Diego, CA (US); Christos LOUIZOS, Amsterdam (NL); Joseph Binamira SORIAGA, San Diego, CA (US)

(21) Appl. No.: 17/997,400

(22) PCT Filed: Jun. 11, 2021
(86) PCT No.: PCT/US2021/037126

§ 371 Date: Oct. 28, 2022

(30) Foreign Application Priority Data
Jun. 12, 2020 (GR) 20200100335

(51) Int. Cl. G06N 3/08; G06F 21/31

(52) U.S. Cl. CPC G06N 3/08; G06F 21/31

(57) ABSTRACT

Certain aspects of the present disclosure provide techniques for authenticating a user based on a machine learning model, including receiving user authentication data associated with a user; generating output from a neural network model based on the user authentication data; determining a distance between the output and an embedding vector associated with the user; comparing the determined distance to a distance threshold; and making an authentication decision based on the comparison.

### CROSS-REFERENCE TO RELATED APPLICATIONS

This application claims the benefit of and priority to Greek Application No. 20200100335, filed Jun. 12, 2020, the entire contents of which are incorporated herein by reference.

### INTRODUCTION

Aspects of the present disclosure relate to machine learning.

Machine learning may produce a trained model (e.g., an artificial neural network, a tree, or other structures), which represents a generalize fit to a set of training data that is known a priori. Applying the trained model to new data produces inferences, which may be used to gain insights into the new data. In some cases, applying the model to the new data is described as “running an inference” on the new data.

Machine learning models are seeing increased adoption across myriad domains, including for use in classification, detection, and recognition tasks. For example, machine learning models are being used to perform complex tasks on electronic devices based on sensor data provided by one or more sensors onboard such devices, such as automatically classifying features (e.g., faces) within images.

One example application for machine learning is user authentication, which is a task of accepting or rejecting users based on their input data (e.g., biometric data). Generally, authentication models need to be trained on large variety of users' data so that the model learns different characteristics of data and can reliably authenticate users. One approach is to centrally collect data of users and train an authentication model. This solution, however, is not privacy-preserving due to the need to have direct access to personal data of users. In user authentication, both raw inputs and embedding vectors are considered sensitive information.

Distributed training of user authentication models, such as using federated learning, suffers similar issues because the embeddings of users are not pre-defined, and thus conventionally they have needed to be defined and associated with a user by a central server. However, this approach is also not privacy-preserving because the server will know the embeddings of users, which is considered sensitive information.

Accordingly, improved methods for training user authentication models with federated learning are needed.

### BRIEF SUMMARY

Certain aspects provide a method, including: generating an error correction code; assigning a unique ID to a user as an information bit vector; obtaining a codeword based on the unique ID assigned to the user; and sending the codeword to the user.

Further aspects provide a method of training a machine learning model for performing user authentication, including: generating output from a neural network model based on user input data; and training the neural network model using a loss function that maximizes a correlation between the output and an embedding vector associated with the user.

Further aspects provide a method for performing user authentication, including: receiving user authentication data associated with a user; generating output from a neural network model based on the user authentication data; determining a distance between the output and an embedding vector associated with the user; comparing the determined distance to a distance threshold; and making an authentication decision based on the comparison.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of how a model can be trained to cluster input data around embedding vectors.

FIG. 2 depicts an example of a federated learning architecture.

FIG. 3 depicts one embodiment of a method for generating pairwise distant embeddings while preserving privacy.

FIG. 4 depicts an example of using an error correction code method for generating embedding vectors.

FIG. 5 depicts an example simplified neural network classification model, which may be used for training an authentication model.

FIG. 6 depicts an example method of training a model, for example using the structure depicted in FIG. 5.

FIG. 7 depicts an example inferencing structure for the simplified neural network classification model of FIG. 5.

FIG. 8 depicts an example method for authenticating a user using a model trained, for example, as described with respect to FIGS. 5 and 6.

FIG. 9 depicts an example processing system that may be configured to perform the methods described herein.

FIG. 10 depicts another example processing system that may be configured to perform aspects of the various methods described herein

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for training user authentication models with federated learning.

Brief Overview of User Authentication with Machine Learning

User authentication generally relates to a task of verifying a user's identity based on some data provided by the user. In some cases, the input data may be sensed data, such as biometric data, like a user's voice, image, fingerprint, and the like.

To construct user authentication as a machine learning problem, assume there is a set of users, uᵢ, i∈{1, . . . , n}, each with data Dᵢ={x_{i,j},yᵢ}, j∈{1, . . . , Tᵢ}, where x_{i,j} is the jth input of user i, Tᵢ is the number of data points for user i, and yᵢ is the corresponding output vector, which may referred to as an embedding.

Generally, embedding refers to methods of representing discrete variables as continuous vectors. For example, an embedding may map a discrete (e.g., categorical) variable to a vector of continuous numbers. In the context of neural networks models, embeddings may be learned continuous vector representations of discrete variables.

A machine learning model, F, may trained on data points with a loss function [symbol] (x,y)=Σᵢ [symbol] (xᵢ,yᵢ), where:

[symbol]

(xᵢ,yᵢ)=Σⱼ(d₁(F(x_{i,j}),yᵢ)−λΣ_{k≠i}d₂(F(x_{i,j}),yₖ)) (Eq. 1)

In Equation 1, above, d₁ and d₂ are distance metrics. During training, for user i, Equation 1 seeks to minimize the distance of output of model F (i.e., F(x_{i,j})) to its embedding yᵢ while also maximizing the distance of the output of model F to other embeddings y_{k,} k≠i.

Assume the model F is deployed on the device of user i. Being queried with a new data point x′, the model authenticates the user if the distance of the model's output to the embedding vector of user i is less than a threshold, i.e., d(F(x′),yᵢ)≤τ, where d is a distance metric and x is the threshold.

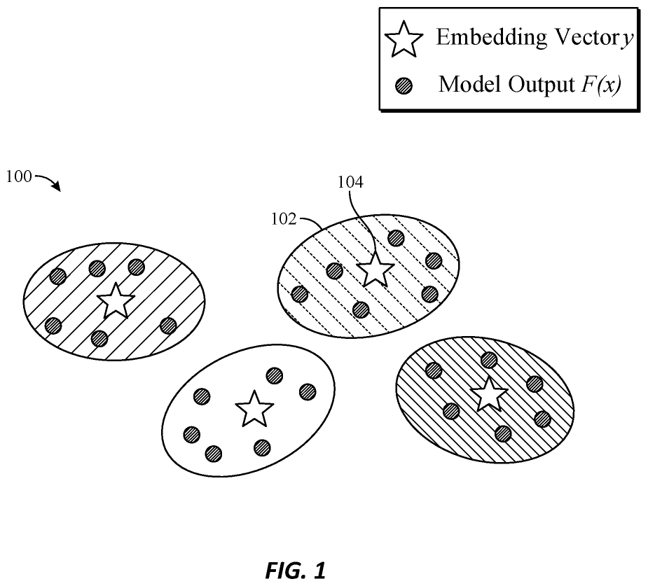

FIG. 1 depicts an example 100 of how model F can be trained to cluster data (e.g., cluster 102) around embedding vectors (e.g., 104) such that the distance of a model output to a corresponding embedding vector of a user is minimized while the distances to embedding vectors of other users are maximized. Note that in FIG. 1, the various patterns in the ovals (e.g., cluster 102) represent different clusters.

### Brief Overview of Federated Learning

Federated learning is a framework for training machine learning models on distributed data. In one example, there may be a server, s, and a set of users, uᵢ, i∈{1, . . . , n}. Each user has access to local data Dᵢ={x_{i,j},y_{i,j}},j∈{1, . . . , Tᵢ}, where (x_{i,j},y_{i,j}) are input/output pairs for the jth input and output of user i. The goal of federated learning then is to allow the server to train a machine learning model on local data of users without having direct access to the local data.

In one example, a federated learning framework may be implemented as follows. First, the server s initializes a global model with weights w. Then, for r={1, . . . , R} rounds of training (or epochs), the server s sends weights of the global model to a selection c of users. The selected users then train the global model based on their local data in order to obtain model updates Δwᵢ for each selected user i∈c. The selected users then send their model updates Δwᵢ to server s. Then server s then updates the weights of the global model according to:

$$w ← w + \frac{{Σ}_{i} {T}_{i} Δ {w}_{i}}{{Σ}_{i} {T}_{i}} \qquad ( Eq . 2 )$$

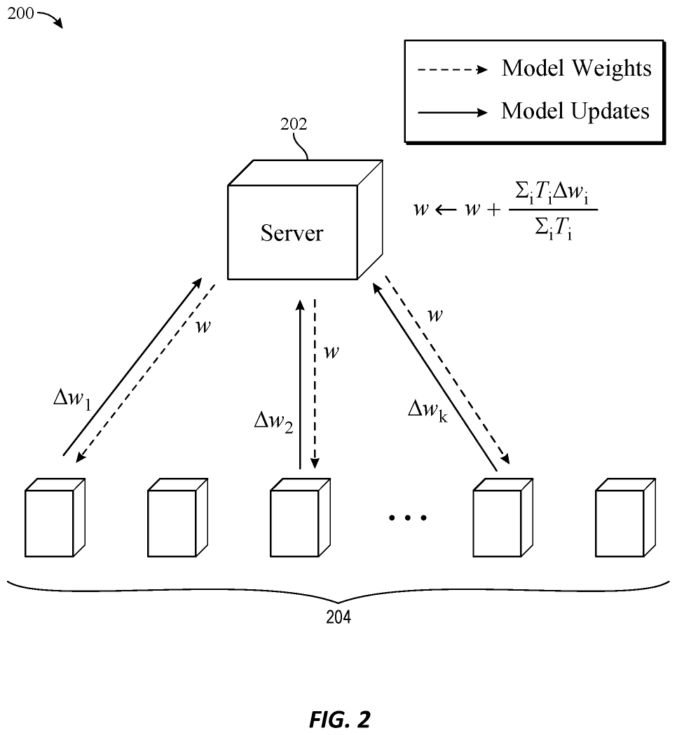

FIG. 2 depicts an example 200 of a federated learning architecture in which server 202 sends weights w of a global machine learning model to selected users (or user devices) 204 for federated learning. The users 204 then send the model updates Δwᵢ, i∈{1 . . . k} to server 202 so that it may update the weights of the global model according to Equation 2.

### User Authentication with Federated Learning

As above, authentication models need to be trained on a large variety of users' data so that the model learns different characteristics of data and can reliably distinguish and authenticate users. For example, speaker recognition models may be trained on speech data of users with different ages, genders, accents, etc. in order to improve the ability to successfully authenticate a user.

One approach is to centrally collect data of users and train the model in a conventional, centralized fashion. This solution, however, is not privacy-preserving due to the need to have direct access to personal data of users. In user authentication, both raw inputs and embedding vectors are considered sensitive information. The embedding vector, particularly, needs to be kept private since it is used to authenticate users.

Protecting data privacy is particularly important in a user authentication application, where the model is likely to be trained and tested in adversarial settings. Specifically, leakage of an embedding vector makes the authentication model vulnerable to both training- and inference-time attacks.

Federated learning enables training with data of large number of users while keeping data private. However, in federated learning of user authentication models, the embeddings of users are not pre-defined.

One approach to define embeddings is that server assigns an ID (e.g., a one-hot vector) to each user. Thus, user i trains the model with pairs (xᵢⱼ, Uᵢ), where Uᵢ is the corresponding one-hot representation of the user ID. This approach, however, has the several drawbacks.

For example, this approach is not privacy-preserving because the server will know the embeddings of users.

Further, the size of the network output will be equal to the number of users, which limits the scalability of the solution. This is because one-hot vector mapping (or encoding) generally requires the size of the output of a neural network to be equal to the number of classes. Unfortunately, this requirement does not scale well for classification tasks in which there are a large number of classes, such as for user authentication where each class is a user and the problem is to classify tens of thousands, or even more, users. In such cases, the number of weights of the last layer of classification model (e.g., the classification stage) becomes very large, which increases the size of the model and therefore the storage requirements of any device running the model, and which also increases the computational complexity of the model.

This model size issue is particularly significant in the federated learning setting because the weights and gradients must be communicated many times between the server and users (e.g., as depicted in FIG. 2), thus creating significant communications overhead and power use. Consequently, training and inferencing become challenging to implement on resource-constrained user devices, such as battery operated devices, mobile electronic devices, edge processing devices, Internet of Things (IoT) devices, and other low-power processing devices.

Another drawback of one-hot mapping is that the number of classes (e.g., users in the case of an authentication model) must be pre-determined before training. In some applications, it is desirable for the model to be able to dynamically handle a variable number of classes without changing the architecture. For example, user classification tasks in a distributed learning context may not know the number of users a priori, and users might be added during the training process. One-hot mapping thus presents a significant limitation in federated learning settings where users might join after training starts.

Another problem that arises is how to train without knowledge of embeddings of other users. Even when each user knows their own embedding vector, they need to have access to embeddings of other users as well in order to train a model with a loss function that seeks to maximize the distance between user-specific embeddings, such as defined above in Equation 1. However, as above, the embedding vector of each user is privacy-sensitive and thus should not be shared with other users or the server. Hence, the challenge is to maximize the pairwise distances between embeddings in a privacy-preserving way.

Embodiments described herein provide a federated learning framework for training user authentication models consisting of at least two improvements over conventional modeling techniques for user authentication.

First, embodiments described herein may implement a method for generating embedding vectors using error correction codes (ECC), which guarantees minimum pairwise distance between embeddings in a privacy-preserving way.

Second, embodiments described herein may implement an improved method for training and authentication with embedding vectors, such as those generated using error correction codes.

### Generating Distant Embeddings while Preserving Privacy

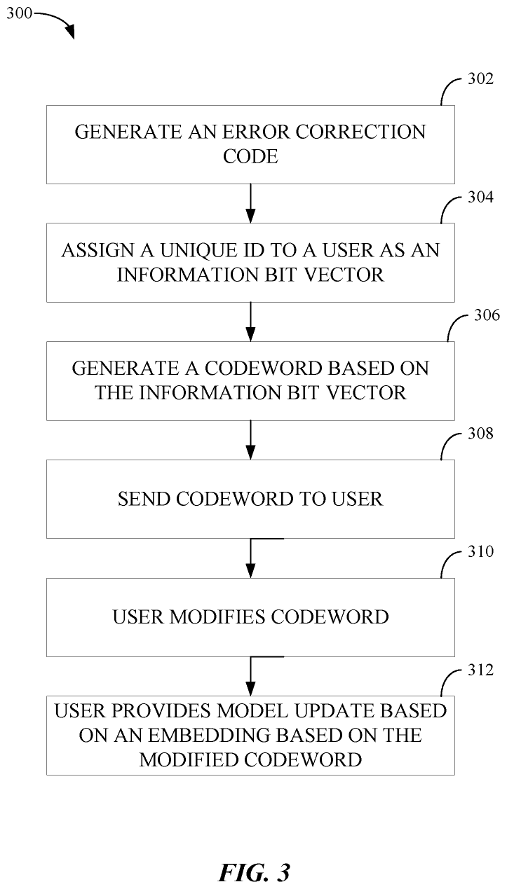

FIG. 3 depicts an example method 300 for generating pairwise distant embeddings for a number of users, nᵤ, while preserving privacy. Method 300 may be performed, for example, by server 202 of FIG. 2.

Method 300 begins at step 302 with generating an error correction code according to an error correction code (ECC) scheme using (n_{c}, nₘ, d) as inputs, where n_{c} is the codeword length, nₘ≥┌log 2(nᵤ)┐ is the number of information bits, and d is the minimum distance of the code.

Method 300 then proceeds to step 304 with assigning a unique ID, Mᵢ to a user i as the information bit vector.

Method 300 then proceeds to step 306 with obtaining a codeword Cᵢ based on M.

Method 300 then proceeds to step 308 with sending the codeword Cᵢ to a user.

Method 300 then proceeds to step 310 with the user changing

$${d}_{min} = ⌊ \frac{d}{3} ⌋$$

bits in random positions of the received codeword and obtaining yᵢ as their individual embedding vector. In this example, the symbol └⋅┘ denotes a floor operation.

Method 300 then proceeds to step 312 with receiving model update data from the user, wherein the model update data is based on a user-specific embedding yᵢ, which is based on the codeword C.

In some embodiments of method 300, obtaining a codeword based on the unique ID comprises using an error correction code (ECC) scheme. In some embodiments, the error correction code scheme comprises a Bose-Chaudhuri-Hocquenghem (BCH) coding scheme. In some embodiments, the error correction code scheme ensures the codeword associated with the user is a threshold distance from any other codeword associated with any other user. For example, method 300 ensures that embeddings of users are at least dₘᵢₙ-separated from each other and from the codewords assigned by server.

In some embodiments, method 300 further includes determining a number of parity bits for the codeword.

To demonstrate the scalability of method 300, a number of users may be set to an arbitrarily high number, such as nᵤ=10 billion.

Then, in a first example, for n_{c}=255, a BCH code may be constructed as (255, 37, 91). Hence,

$${d}_{min} \geq \frac{91}{3} > 30.$$

In another example, for n_{c}=511 a BCH code may be constructed as (511, 40, 191). Hence,

$${d}_{min} \geq \frac{191}{3} > 63.$$

In another example, for n_{c}=1023, a BCH code may be constructed as (1023, 36, 447). Hence,

$${d}_{min} \geq \frac{447}{3} > 149.$$

In another example, for n_{c}=2047, a BCH code may be constructed as (2047, 34, 959). Hence,

$${d}_{min} \geq \frac{959}{3} > 319.$$

These examples show that even for extremely large numbers of users, it is possible to construct codes with orders of magnitude smaller length of the codeword while also guaranteeing high minimum separability.

Note that FIG. 3 is just one example of a method, and other methods including fewer, additional, or alternative steps are possible consistent with this disclosure.

Further, in other aspects, the server (e.g., 202 of FIG. 2) may determine a length of an embedding vector and send that to the user, which can generate a random embedding vector based on the length.

For example, given a number of users and desired minimum distance dₘᵢₙ, the server can determine a length of the embedding vector nₑ such that the minimum distance of random embedding vectors is more than τ with probability of at least q according to:

$$Pr ( {d}_{min} \geq τ ) \geq {\prod }_{k = 0}^{n - 1} 1 - \frac{k \times {V}_{τ}}{{2}^{{n}_{e}}} , \\ where {V}_{τ} = {\sum }_{d = 0}^{τ - 1} ( \frac{{n}_{e}}{d} ) ,$$

and k is the number of user inputs.

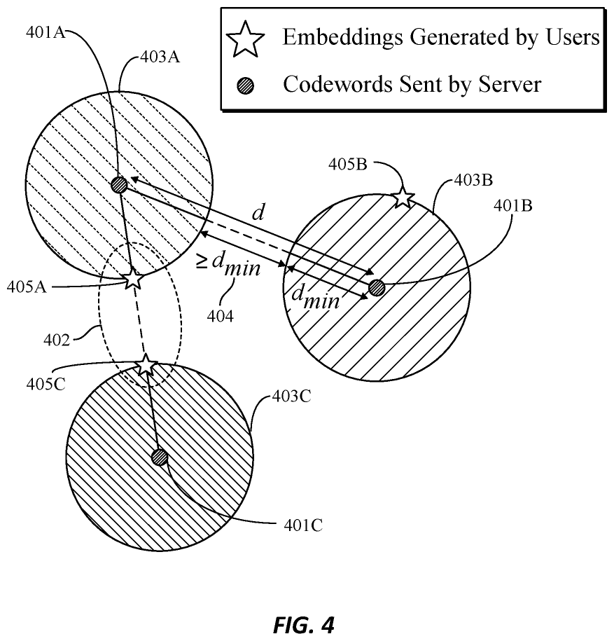

FIG. 4 depicts an example of using an ECC method for generating embedding vectors.

As in step 310 of method 300, users may generate embeddings 405A-405C by changing

$${d}_{min} = ⌊ \frac{d}{3} ⌋$$

bits of codewords sent by a server 401A-401C. This change of bits creates random spaces 403A-403C around the codewords 401A-401C, respectively.

In the worst case, a generated embedding (e.g., 405A) may be toward a codeword (e.g., 410C) and embedding (405C) of another user, as in the example indicated at 402. But even in the worst case, the generated embeddings are guaranteed to be at least dₘᵢₙ distance separated from each other and from the codewords assigned by server, such as shown at 404.

### Training and Authentication with Generated Embeddings

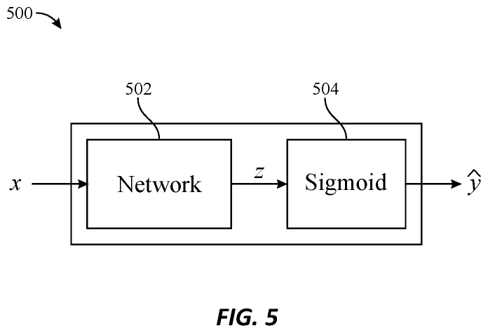

FIG. 5 depicts an example 500 of a simplified neural network classification model, which may be used for training an authentication model. In this example, input x is processed by a machine learning model, such as neural network 502, and then by a non-linear activation function 504, such as sigmoid, to generate the model output 9. In some examples, input x may be a biometric data input, such as a fingerprint, face scan, iris scan, voice data, or the like, used for performing user authentication.

The sigmoid activation function 504 may be used to allow for random binary embedding. In random binary embedding, a set of unique random binary embeddings (e.g., vectors) is generated with minimum separation from one another, and each one of these vectors may be associated with a user. The size of the random binary embeddings may be chosen such that the minimum difference between any two embeddings is more than a threshold difference with high probability.

To implement random binary embedding, the model structure of a neural network-based classification model may be modified for both training and inferencing. Specifically, in a training context, the classification model structure is modified compared to conventional structures in that the output of the network (e.g., Z) is processed by a sigmoid nonlinear operation (e.g., 504). The Sigmoid operation is an element-wise nonlinear function that maps its input to a value between 0 and 1 for each element, and may be defined as:

$${\hat{Y}}_{i} = \frac{exp ( {Z}_{i} )}{1 + exp ( {Z}_{i} )} . \qquad ( Eq . 3 )$$

The Sigmoid function allows every element (e.g., a bit in a binary vector) in a model output vector to be treated independently, rather than having the sum of the elements necessarily equal to one, as with Softmax.

A benefit of binary embeddings is that a number of parameters in the last layer of a model (e.g., a fully connected layer) is significantly reduced as compared to conventional methods, such as one-hot encoding.

As described above, error correction codes may be used to generate initial embeddings with guaranteed minimum separation. When using a coded binary embedding method, the embeddings may be referred to as codewords.

Generally, a codeword C may be generated by concatenating (⋅∥⋅) M information bits and P parity bits, e.g., C=M∥P, where P is a function of M. Such encoding can beneficially guarantee the pairwise distance between any two codewords.

For coded binary embedding, binary representation of classes (e.g., user IDs) are used as information bits M of the codeword C. Coding can then be done using various error correction coding (ECC) schemes, such as Reed-Muller (RM) encoding, convolution-based encoding, and Bose-Chaudhuri-Hocquenghem (BCH) codes, to name a few.

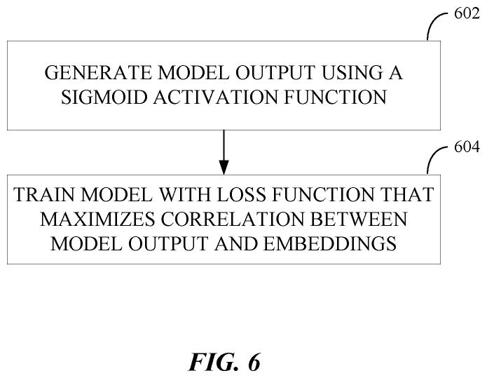

FIG. 6 depicts an example method 600 of training a model, for example using the structure depicted in FIG. 5.

Initially, let the length of model output be n_{c}, where each output element can independently be 0 or 1. To make sure model outputs elements are in the range of [0,1], the output of the model is passed through a sigmoid nonlinear activation function, as described above, which forces each output element into the range of [0,1].

Method 600 thus begins at step 602 with generating model output 9 based on a sigmoid non-linear function.

Method 600 then proceeds to step 604 with training the model using a loss function that maximizes correlation between the model output and the embeddings. In one example, the loss function is:

$$L ( y , \hat{y} ) = - \frac{1}{{n}_{c}} {Σ}_{i} {\hat{y}}_{i} ( 2 {y}_{i} - 1 ) , \qquad ( Eq . 4 )$$

where y is the embedding vector. This loss function serves to increase the correlation between y and ŷ. In other words, when y is 1, this loss function encourages ŷ to be near 1, and when y is 0, this loss function encourages ŷ to be near 0.

In some aspects, the embedding vector is based on a codeword received from a federated learning server, such as server 202 in FIG. 2. As described above, the codeword may be based on an error correction code scheme, as described with respect to FIG. 3.

Note that FIG. 6 is just one example of a method, and other methods including fewer, additional, or alternative steps are possible consistent with this disclosure.

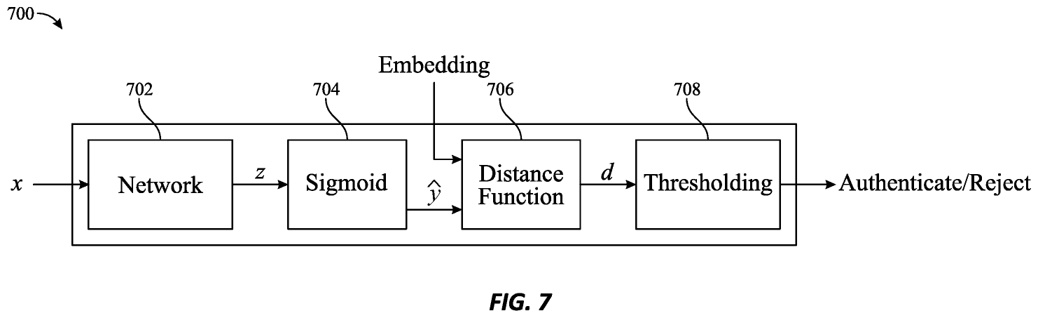

FIG. 7 depicts an example inferencing structure 700 for the simplified neural network classification model of FIG. 5.

In this example, the inferencing structure includes a trained model 702 (e.g., a neural network model trained according to the method described in FIG. 6) and a sigmoid non-linear activation function 704.

The output of the sigmoid function is then compared to an embedding associated with a user based on a distance function 706. For example, an L2 norm (Euclidean) distance function many be used. The embedding may be generated as discussed above with respect to FIG. 3.

The distance measure d generated by the distance function 706 is then compared to a predetermined threshold at 708. This comparison leads to a determination of a successful authentication or failed authentication.

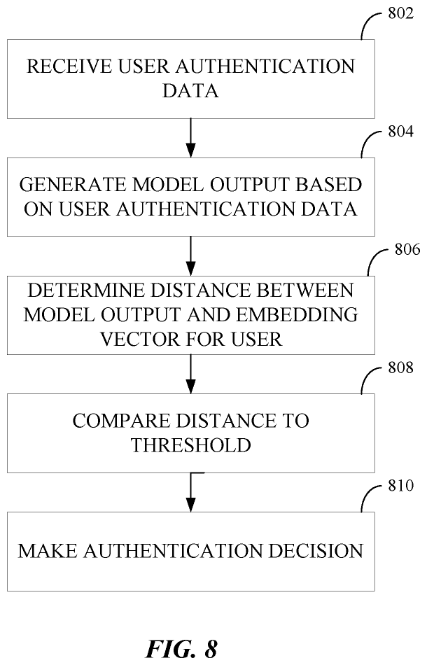

FIG. 8 depicts an example method 800 for authentication using a model, such as described with respect to FIG. 7, which may be trained, for example, as described with respect to FIGS. 5 and 6.

Method 800 begins at step 802 with receiving user authentication data. For example, the user authentication data input may include audio data (e.g., a voice sample), video or image data (e.g., a picture of a face or an eye), sensor data (e.g., a fingerprint sensor or multi-point depth sensor), other biometric data, and combinations of the same.

Method 800 then proceeds to step 804 with generating model output based on the user authentication data. In some embodiments, the model output 9 is based on a sigmoid non-linear activation function (e.g., an output from sigmoid function 704 in FIG. 7).

Method 800 then proceeds to step 806 with determining a distance between the model output 9 and an embedding for the user y. In one example, for an input x, the distance of model output to embedding vector is computed as an L2 norm distance according to: d=∥ŷ−y∥₂, where F is the model, y is the embedding vector of user, and ŷ is the model output, which is generated by σ(F(x)).

Method 800 then proceeds to step 808 with comparing the determined distance to a threshold τ.

Method 800 then proceeds to step 810 with making an authentication decision based on the comparison. For example, if the distance d is less than the threshold τ, then the input is authenticated, otherwise it is rejected.

In some embodiments, the threshold τ may be determined such that the True Positive Rate (TPR) is more than a value, such p=90%. The TPR is defined as the rate that the true user is correctly authenticated.

In some embodiments of method 800, a “warm-up phase” is performed on the model. In the warm-up phase, several inputs, xᵢ, of the user are collected and corresponding distances, dᵢ, are computed. The threshold is then set such that a fraction p of inputs are authenticated.

Note that FIG. 8 is just one example of a method, and other methods including fewer, additional, or alternative steps are possible consistent with this disclosure.

### Example Processing Systems

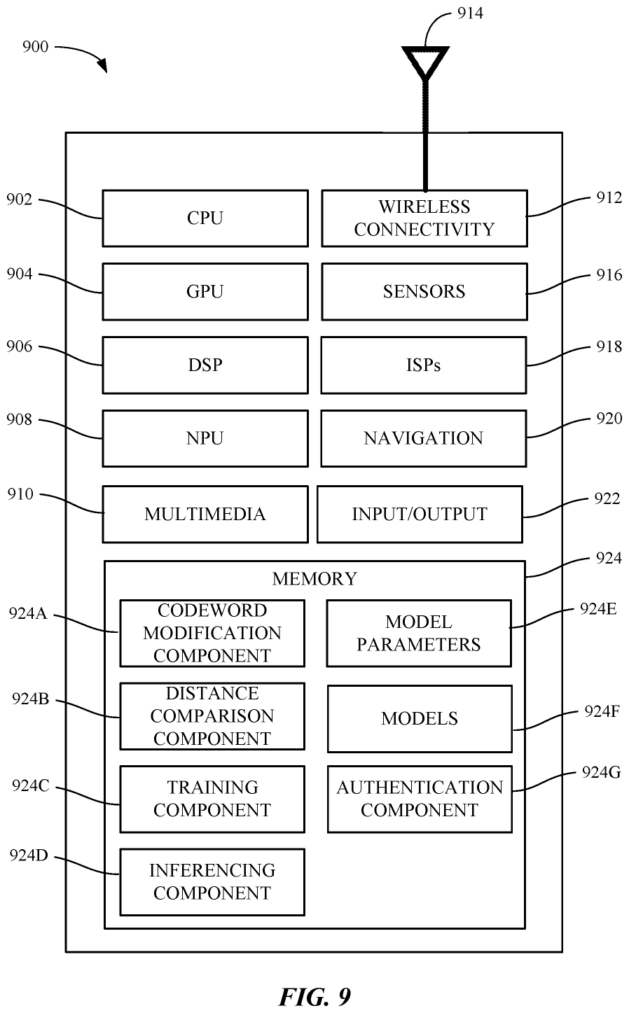

FIG. 9 depicts an example processing system 900 that may be configured to perform aspects of the various methods described herein, including, for example, the methods described with respect to FIGS. 3, 6 and 8. For example, processing system 900 may be a user device participating in federated learning of a user authentication model, such as described with respect to FIG. 2.

Processing system 900 includes a central processing unit (CPU) 902, which in some examples may be a multi-core CPU. Instructions executed at the CPU 902 may be loaded, for example, from a program memory associated with the CPU 902 or may be loaded from a memory 924.

Processing system 900 also includes additional processing components tailored to specific functions, such as a graphics processing unit (GPU) 904, a digital signal processor (DSP) 906, a neural processing unit (NPU) 908, a multimedia processing unit 910, and a wireless connectivity component 912.

An NPU, such as 908, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), or vision processing unit (VPU).

NPUs, such as 908, may be configured to accelerate the performance of common machine learning tasks, such as image classification, sound classification, authentication, and various other predictive tasks. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on trained models. Such NPUs may thus be configured to input a new piece of data and rapidly process it through an already trained model to generate a model output (e.g., an inference).

Though not depicted in FIG. 9, NPU 908 may be implemented as a part of one or more of CPU 902, GPU 904, and/or DSP 906.

In some examples, wireless connectivity component 912 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity processing component 912 is further connected to one or more antennas 914.

Processing system 900 may also include one or more sensor processing units 916 associated with any manner of sensor, one or more image signal processors (ISPs) 918 associated with any manner of image sensor, and/or a navigation processor 920, which may include satellite-based positioning system components (e.g., GPS or GLONASS) as well as inertial positioning system components. In some embodiments, the sensor processing units may be configured to capture authentication data from a user, such as image data, audio data, biometric data, and other types of sensory data.

Processing system 900 may also include one or more input and/or output devices 922, such as screens, touch-sensitive surfaces (including touch-sensitive displays), physical buttons, speakers, microphones, and the like.

In some examples, one or more of the processors of processing system 900 may be based on an ARM or RISC-V instruction set.

Processing system 900 also includes memory 924, which is representative of one or more static and/or dynamic memories, such as a dynamic random access memory, a flash-based static memory, and the like. In this example, memory 924 includes computer-executable components, which may be executed by one or more of the aforementioned processors of processing system 900.

In this example, memory 924 includes codeword modification component 924A, distance comparison component 924B, training component 924C, inferencing component 924D, model parameters 924E, models 924F (e.g., user authentication models), and authentication component 924G. The depicted components, and others not depicted, may be configured to perform various aspects of the methods described herein.

Note that FIG. 9 is just one example of a processing system, and other processing systems including fewer, additional, or alternative aspects are possible consistent with this disclosure.

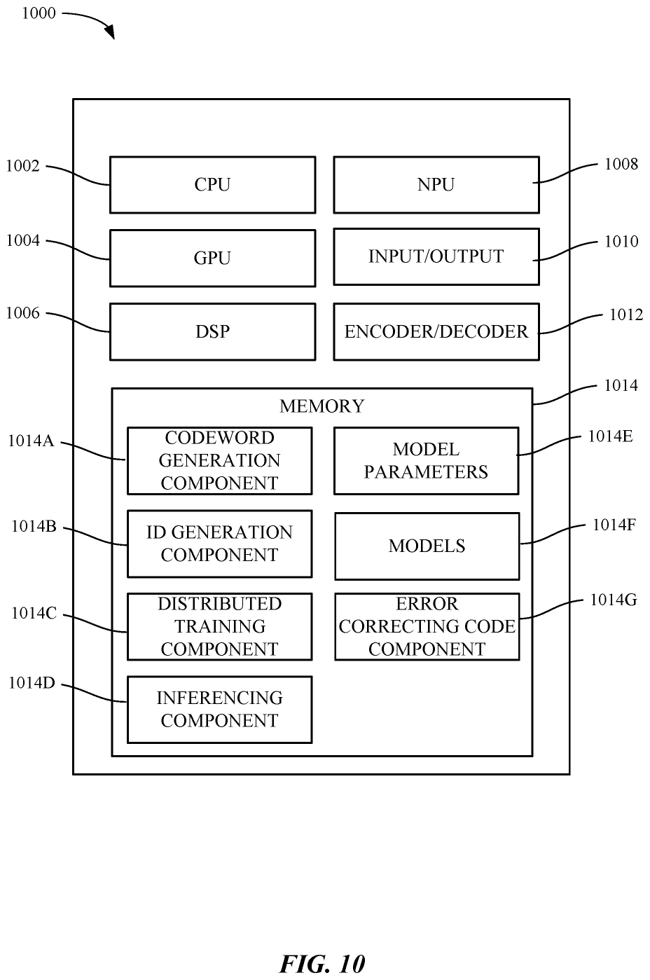

FIG. 10 depicts an example processing system 1000 that may be configured to perform aspects of the various methods described herein, including, for example, the methods described with respect to FIGS. 3 and 8. For example, processing system 1000 may be a server participating in federated learning of a user authentication model, such as described with respect to FIG. 2.

Processing system 1000 includes a central processing unit (CPU) 1002, which in some examples may be a multi-core CPU. Instructions executed at the CPU 1002 may be loaded, for example, from a program memory associated with the CPU 1002 or may be loaded from a memory 1024.

Processing system 1000 also includes additional processing components tailored to specific functions, such as a graphics processing unit (GPU) 1004, a digital signal processor (DSP) 1006, and a neural processing unit (NPU) 1008.

Though not depicted in FIG. 10, NPU 1008 may be implemented as a part of one or more of CPU 1002, GPU 1004, and/or DSP 1006.

Processing system 1000 may also include one or more sensor processing units 1016 associated with any manner of sensor, one or more image signal processors (ISPs) 1018 associated with any manner of image sensor, and/or a navigation processor 1020, which may include satellite-based positioning system components (e.g., GPS or GLONASS) as well as inertial positioning system components. In some embodiments, the sensor processing units may be configured to capture authentication data from a user, such as image data, audio data, biometric data, and other types of sensory data.

Processing system 1000 may also include one or more input and/or output devices 1022, such as screens, physical buttons, speakers, microphones, and the like.

In some examples, one or more of the processors of processing system 1000 may be based on an ARM or RISC-V instruction set.

Processing system 1000 may also include a hardware-based encoder/decoder 1012, configured to efficiently perform encoding and decoding functions. For example, the encoder/decoder 1012 may be configured to perform one or more of: a Bose-Chaudhuri-Hocquenghem (BCH) coding scheme, a Reed-Muller (RM) coding scheme, and a convolution-based coding scheme.

Processing system 1000 also includes memory 1014, which is representative of one or more static and/or dynamic memories, such as a dynamic random access memory, a flash-based static memory, and the like. In this example, memory 1014 includes computer-executable components, which may be executed by one or more of the aforementioned processors of processing system 1000.

In this example, memory 1014 includes codeword generation component 1014A, user ID generation component 1014B, distributed training component 1014C (e.g., configured for performing federated learning), inferencing component 1014D, model parameters 1014E, models 1014F (e.g., user authentication models), and error correction code component 1014G. The depicted components, and others not depicted, may be configured to perform various aspects of the methods described herein.

Note that FIG. 10 is just one example of a processing system, and other processing systems including fewer, additional, or alternative aspects are possible consistent with this disclosure.

### Example Clauses

Implementation examples are described in the following numbered clauses:

Clause 1: A method, comprising: receiving user authentication data associated with a user; generating output from a neural network model based on the user authentication data; determining a distance between the output and an embedding vector associated with the user; comparing the determined distance to a distance threshold; and making an authentication decision based on the comparing.

Clause 2: The method of Clause 1, wherein the user authentication data comprises one or more of: audio data, video data, image data, sensor data, or biometric data.

Clause 3: The method of any one of Clauses 1-2, wherein the neural network model is configured with a sigmoid non-linear activation function for generating the output.

Clause 4: The method of any one of Clauses 1-3, wherein: the distance between the output and the embedding vector associated with the user is computed according to d=∥ŷ−y∥₂, x is the user authentication data, F is the neural network model, y is the embedding vector associated with the user, and σ(F(x)) generates the output.

Clause 5: The method of any one of Clauses 1-4, wherein making an authentication decision further comprises authenticating the user based on the user authentication data if the distance between the output and an embedding vector associated with the user is less than the distance threshold.

Clause 6: The method of Clause 5, wherein: the distance threshold is configured such that a True Positive Rate (TPR) is equal to or greater than 90%, and the TPR is defined as a rate that the user is correctly authenticated.

Clause 7: A method, comprising: generating an error-correcting code; assigning a unique ID to a user as an information bit vector; obtaining a codeword based on the unique ID assigned to the user; and sending the codeword to the user.

Clause 8: The method of Clause 7, further comprising modifying the codeword.

Clause 9: The method of Clause 8, wherein modifying the codeword comprises the user changing a predetermined number of bits in random positions of the codeword to a user-specific embedding vector.

Clause 10: The method of any one of Clauses 8-9, wherein the predetermined number of bits is

$${d}_{min} = ⌊ \frac{d}{3} ⌋ bits .$$

Clause 11: The method of any one of Clauses 7-10, further comprising: receiving model update data from the user, wherein the model update data is based on a user-specific embedding based on the codeword.

Clause 12: The method of any one of Clauses 7-11, wherein the error correction code is generated according to (n_{c}, nₘ, d), where n_{c} is a codeword length, nₘ≥┌log 2(nᵤ)┐ is a number of information bits, nᵤ is a number of users, and d is a minimum distance of the code.

Clause 13: The method of any one of Clauses 7-12, wherein obtaining a codeword based on the unique ID comprises using an error correction code scheme.

Clause 14: The method of Clause 13, wherein the error correction code scheme comprises a Bose-Chaudhuri-Hocquenghem (BCH) coding scheme.

Clause 15: The method of Clause 13, wherein the error correction code scheme ensures the codeword associated with the user is a threshold distance from any other codeword associated with any other user.

Clause 16: The method of Clause 13, further comprising: determining a number of parity bits for the codeword.

Clause 17: A method, comprising: generating output from a neural network model based on user input data; and training the neural network model using a loss function that maximizes a correlation between the output and an embedding vector associated with a user, wherein the embedding vector is based on a codeword received from a federated learning server.

Clause 18: The method of Clause 17, wherein the neural network model comprises a sigmoid non-linear activation function for generating the output.

Clause 19: The method of any one of Clauses 17-18, wherein: the loss function is

$$L ( y , \hat{y} ) = - \frac{1}{{n}_{c}} {Σ}_{i} {\hat{y}}_{i} ( 2 {y}_{i} - 1 ) ,$$

ŷ is the output from the neural network model, y is the embedding vector associated with the user, the loss function is configured to increase the correlation between y, ŷ.

Clause 20: The method of any one of Clauses 17-19, wherein the codeword is based on an error correction code scheme.

Clause 21: The method of any one of Clauses 17-20, further comprising: determining one or more model updates based on the training; and sending the model updates to a server.

Clause 22: A processing system, comprising: a memory comprising computer-executable instructions; and a processor configured to execute the computer-executable instructions and cause the processing system to perform a method in accordance with any one of Clauses 1-21.

Clause 23: A non-transitory computer-readable medium comprising computer-executable instructions that, when executed by a processor of a processing system, cause the processing system to perform a method in accordance with any one of Clause 2 1-21.

Clause 24: A computer program product embodied on a computer readable storage medium comprising code for performing a method in accordance with any one of Clauses 1-21.

Clause 25: A processing system, comprising means for performing a method in accordance with any one of Clauses 1-21.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A method, comprising:
receiving user authentication data associated with a user;
generating output from a neural network model based on the user authentication data;
determining a distance between the output and an embedding vector associated with the user;
comparing the determined distance to a distance threshold; and
making an authentication decision based on the comparing.

2. The method of claim 1, wherein the user authentication data comprises one or more of: audio data, video data, image data, sensor data, or biometric data.

3. The method of claim 1, wherein the neural network model is configured with a sigmoid non-linear activation function for generating the output.

4. The method of claim 1, wherein:
the distance between the output and the embedding vector associated with the user is computed according to d=∥ŷ−y∥₂,
x is the user authentication data,
F is the neural network model,
y is the embedding vector associated with the user, and
ŷ is the model output.

5. The method of claim 1, wherein making an authentication decision further comprises authenticating the user based on the user authentication data if the distance between the output and the embedding vector associated with the user is less than the distance threshold.

6. The method of claim 5, wherein:
the distance threshold is configured such that a True Positive Rate (TPR) is equal to or greater than 90%, and
the TPR is defined as a rate that the user is correctly authenticated.

7. A method, comprising:
generating an error-correcting code;
assigning a unique ID to a user as an information bit vector;
obtaining a codeword based on the unique ID assigned to the user; and
sending the codeword to the user.

8. The method of claim 7, further comprising modifying the codeword.

9. The method of claim 8, wherein modifying the codeword comprises the user changing a predetermined number of bits in random positions of the codeword to a user-specific embedding vector.

10. The method of claim 8, wherein the predetermined number of bits is
$${d}_{min} = ⌊ \frac{d}{3} ⌋ bits .$$

11. The method of claim 7, further comprising receiving model update data from the user, wherein the model update data is based on a user-specific embedding based on the codeword.

12. The method of claim 7, wherein the error correction code is generated according to (n_{c}, nₘ, d), where n_{c} is a codeword length, nₘ≥┌log 2(nᵤ)┐ is a number of information bits, nᵤ is a number of users, and d is a minimum distance of the code.

13. The method of claim 7, wherein obtaining a codeword based on the unique ID comprises using an error correction code scheme.

14. The method of claim 13, wherein the error correction code scheme comprises a Bose-Chaudhuri-Hocquenghem (BCH) coding scheme.

15. The method of claim 13, wherein the error correction code scheme ensures the codeword associated with the user is a threshold distance from any other codeword associated with any other user.

16. The method of claim 13, further comprising: determining a number of parity bits for the codeword.

17. A method, comprising:
generating output from a neural network model based on user input data; and
training the neural network model using a loss function that maximizes a correlation between the output and an embedding vector associated with a user, wherein the embedding vector is based on a codeword received from a federated learning server.

18. The method of claim 17, wherein the neural network model comprises a sigmoid non-linear activation function for generating the output.

19. The method of claim 17, wherein:
the loss function is
$$L ( y , \hat{y} ) = - \frac{1}{{n}_{c}} {Σ}_{i} {\hat{y}}_{i} ( 2 {y}_{i} - 1 ) ,$$
ŷ is the output from the neural network model,
y is the embedding vector associated with the user, and
the loss function is configured to increase the correlation between y, y.

20. The method of claim 17, wherein the codeword is based on an error correction code scheme.

21. The method of claim 17, further comprising:
determining one or more model updates based on the training; and
sending the model updates to a server.

22. A processing system comprising:
a memory comprising computer-executable instructions; and
at least one processor configured to execute the computer-executable instructions and cause the processing system to perform operations comprising:
receiving user authentication data associated with a user;
generating output from a neural network model based on the user authentication data;
determining a distance between the output and an embedding vector associated with the user;
comparing the determined distance to a distance threshold; and
making an authentication decision based on the comparing.

23. (canceled)

24. (canceled)

25. (canceled)

26. The processing system of claim 22, wherein the user authentication data comprises one or more of: audio data, video data, image data, sensor data, or biometric data.

27. The processing system of claim 22, wherein the neural network model is configured with a sigmoid non-linear activation function for generating the output.

28. The processing system of claim 22, wherein:
the distance between the output and the embedding vector associated with the user is computed according to d=∥ŷ−y∥₂,
x is the user authentication data,
F is the neural network model,
y is the embedding vector associated with the user, and
ŷ is the model output.

29. The processing system of claim 22, wherein making the authentication decision comprises authenticating the user based on the user authentication data if the distance between the output and the embedding vector associated with the user is less than the distance threshold.

30. The processing system of claim 29, wherein:
the distance threshold is configured such that a True Positive Rate (TPR) is equal to or greater than 90%, and
the TPR is defined as a rate at which the user is correctly authenticated.
